(19) United States
(12) Patent Application Publication
(10) Pub. No.: US 2017/0336612 A1
(43) Pub. Date: Nov. 23, 2017

(54) Inhomogeneous Surface Wave Microscope

(71) Applicant: Jonathan J. Foley, IV, Wayne, NJ (US)

(72) Inventor: Jonathan J. Foley, IV, Wayne, NJ (US)

(21) Appl. No.: 15/159,761

(22) Filed: May 19, 2016

(51) Int. Cl. G02B 21/16; G02B 5/00; G02B 21/33; G02B 21/00; G02B 5/04; G02B 21/02; G02B 27/56; B82Y 20/00

(52) U.S. Cl. CPC G02B 21/16; G02B 21/02; G02B 5/008; G02B 27/56; G02B 21/33; G02B 21/0092; G02B 5/04; B82Y 20/00; Y10S 977/755

(57) ABSTRACT

A method for improving the lateral resolution of fluorescence microscopy using inhomogeneous surface wave microscopy is provided. The microscope includes a prism on which laterally-interfaced plasmonic nanofilms are deposited (here called metal 1 and metal 2, though materials other than metals may be used, see Claim 1). A propagating wave which has evanescent character along one spatial dimension, known as a surface plasmon polariton, is excited on the first metal nanofilm by focusing of monochromatic incident light with a particular incident angle through the prism. Propagation of the surface plasmon polariton across the interface between the metal 1 nanofilm and the metal 2 nanofilm creates a propagating wave with evanescent character in two spatial dimensions, known as an inhomogeneous surface plasmon polariton [3]. A key property of inhomogeneous surface plasmon polaritons is the external controllability of the evanescent character of the wave in both the axial and lateral dimensions, which imparts the ability to judiciously enhance lateral resolution of conventional total internal reflection fluorescence microscopy with only minor modifications to the device.

### 1. FIELD OF THE INVENTION

The present invention relates to Inhomogeneous Surface Wave Microscopy, which involves a method for improving the lateral resolution in performing fluorescence observation by the use of inhomogeneous optical surface waves known as inhomogeneous surface plasmon polaritons. Inhomogeneous surface plasmon polaritons are evanescent in axial and lateral dimensions, and generated by refraction of optical surface waves known as surface plasmon polariton across metal-metal interfaces. This invention utilizes a total internal reflection prism supporting laterally-interfaced metal nanofilms that can support the desired evanescent optical waves.

### 2. BRIEF SUMMARY OF INVENTION

Inhomogeneous Surface Wave Microscopy offers new capabilities for significantly enhancing the lateral resolution available in current state-of-the-art fluorescence microscopy techniques that rely on evanescent excitation of fluorophore labels, namely Total Internal Reflection Microscopy [1, 2]. This invention leverages a newly-discovered class of evanescent surface waves known as inhomogeneous surface plasmon polaritons [3]. A key part of the invention is a total internal reflection prism supporting two different metal nanofilms laterally interfaced with one another, which is used to support the desired evanescent waves. This novel substrate requires deposition of nanoscopically-thin (˜50 nm) layers of plasmonic materials (e.g. silver and gold) on a total internal reflection prism, made, for example, glass, which can have comparable form factor as a standard microscope slide or prisms used in conventional Total Internal Reflectance Fluorescence Microscopy [1,2]. Hence, this novel substrate can be integrated into existing Total Internal Reflection Microscopy setups with only minor modifications. The Inhomogeneous Surface Wave Microscopy setup is illustrated in FIG. 1, and the novel substrate is illustrated in FIG. 2. This invention addresses the pressing need to increase the lateral resolution of microscopy-based imaging without relying non-linear absorption processes or other phenomena which require high-intensity illumination that can induce molecular and cellular damage, thereby altering the underlying structures and behaviors these techniques seek to study [4].

### 3. BRIEF DESCRIPTION OF THE DRAWINGS

FIG. 1: Schematic illustration of the Inhomogeneous Surface Wave microscope.

FIG. 2: Schematic illustration of a total internal reflection prism on which laterally-interfaced metal nanofilms are deposited, which is a substrate that can support inhomogeneous surface plasmon polaritons for enabling Inhomogeneous Surface Wave microscopy.

FIG. 3: Top-down view of lateral interface between metal 1 nanofilm and metal 2 nanofilm, and illustration of relevant propagation directions of the optical waves.

FIG. 4: Illustration of an inhomogeneous surface plasmon polariton which is evanescent along both an axial and a lateral dimension.

### 4. DETAILED DESCRIPTION OF THE INVENTION

The invention and method presented here are illustrated schematically on an inverted microscope setup where the objective lens is below the sample being imaged. However, the method is applicable to upright setups where the objective lens is above the sample being imaged.

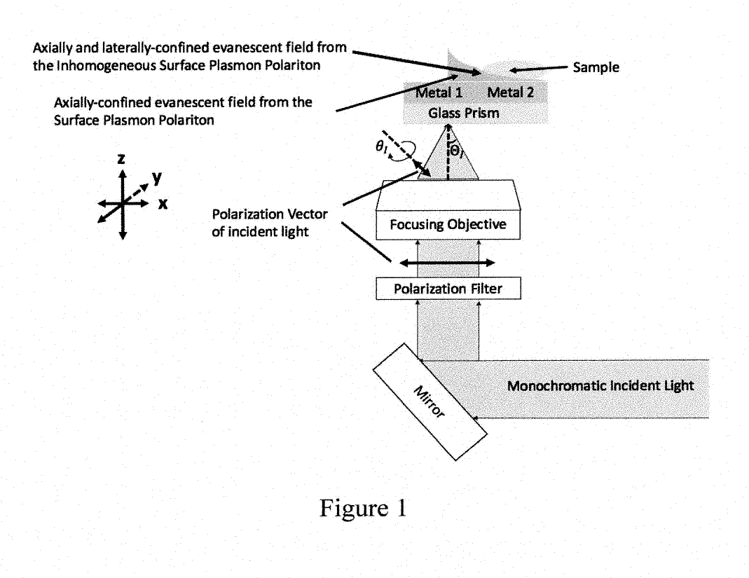

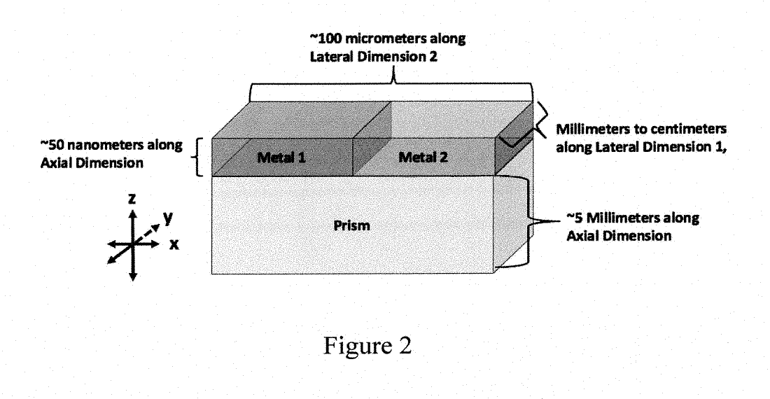

FIG. 1 shows the embodiment of the invention in an inverted microscope configuration. The substantive modification to a total internal reflection fluorescence microscope is the deposition of laterally-interfaced metal nanofilms on the total internal reflection prism. The monochromatic light of wavelength λ is focused by the objective to large angles of incident relative to the surface normal of the prism substrate on which the metal 1 nanofilm is deposited. The dielectric constant of the prism substrate will be denoted ∈ₚᵣᵢₛₘ and the dielectric constant of the metal 1 nanofilm at wavelength λ will be denoted ∈ₘ(λ), where ∈ₘ(λ) is understood to be a complex number which depends on the value of the wavelength, λ. A surface plasmon polariton is excited on the metal 1 nanofilm when the following condition is met:

$$\sqrt{{ε}_{prism}} sin ( {Θ}_{I} ) = \sqrt{\frac{{ε}_{m} ( λ ) \cdot {ε}_{S}}{{ε}_{m} ( λ ) + {ε}_{S}}} ,$$

where ∈_{S} indicates the dielectric constant of the sample/substrate placed on top of the metal nanofilms. A general requirement is that ∈ₚᵣᵢₛₘ>∈_{S}, such that total internal reflection would result for some critical angle of incidence of light incident from the prism side if the prism were interfaced directly with the superstrate material. This requirement can be met by many materials (see Claim 2). Similar to the optical field resulting from total internal reflection, this surface plasmon polariton field is evanescent in the axial dimension (along the z-axis) [3] (see illustration of Axially-confined evanescent field from Surface Plasmon Polariton in FIG. 1). An inhomogeneous surface plasmon polariton is created on the metal 2 nanofilm, and this wave has evanescent character in both the axial dimension (along the z-axis) and in lateral dimension 1 (along the y-axis) (see FIG. 1 and FIG. 2 for illustration of the coordinate system); it is this 2-dimensional evanescent character that allows for selective excitation of fluorophores in a limited area of the sample and thereby imparts enhanced lateral imaging resolution.

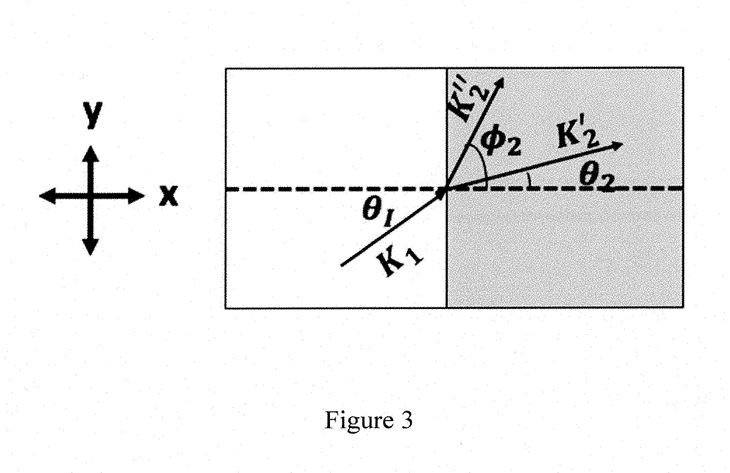

Surface plasmon polaritons propagate along the surface of the metal 1 nanofilm with a direction that will be dictated by the angle (θ_{I}) of the polarization vector of the incident light in the lateral plane (in the x-y plane). The precise angle θ_{I} of the polarization vector in the x-y plane can be controlled using a polarization filter, as illustrated in FIG. 1, and has direct correspondence to the angle θ_{I} illustrated in FIG. 3 that shows the relative angle of the surface plasmon polariton propagation direction normal to the metal 1/metal 2 interface.

When the surface plasmon polariton propagates across the metal 1/metal 2 interface, it will undergo a complex refraction process. The refraction process is referred to as complex because the propagation vector of the surface plasmon polariton is a complex quantity: it has a real component related to its momentum, and an imaginary component related to its evanescent character. The refraction of these components usually occurs at different angles, leading to a complex generalization of Snell's law, with a set of relations for the refraction angle of the real component of the propagation vector (θ₂) and a set of relations for the refraction angle of the imaginary component of the propagation vector (φ₂).

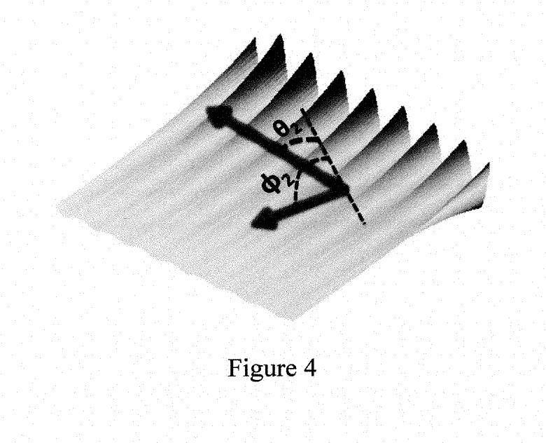

FIG. 2 shows illustrate that the metal nanofilms should be approximately 50 nm in thickness along the axial dimension (along the z-axis in the figure coordinate system) in order to allow efficient excitation of surface waves. The lateral dimension 1 of the nanofilms (along the y-axis in the figure coordinate system) can be much larger, and may be determined according to specifications relating to the specimen sizes and desired coverage of specimens. Lateral dimension 2 of the nanofilm (along the x-axis in the figure coordinate system) should be on the order of ˜100 micrometers; surface plasmon polaritons will lose significant electric field intensity after propagating more than 100 micrometers, which will limit the efficacy of fluorophore excitation beyond this distance from the interface between metal 1 and metal 2. As illustrated in FIG. 3, these angles can be substantially different, causing the components of the refracted propagation vector to point in substantially different directions. A wave of this type is called an inhomogeneous wave, and a surface plasmon polariton with this character is called an inhomogeneous surface plasmon polariton [3]. When the difference between θ₂ and φ₂ is large, then the inhomogeneous surface wave can take on substantial evanescent character in the lateral dimension. This feature is illustrated in FIG. 4. The degree of evanescent character can be quantified by a measured called the confinement length which is defined by

$${L}_{C} = \frac{λ}{4 π {K}_{2} sin ( {θ}_{2} - {φ}_{2} )} ,$$

where λ is the incident wavelength, and K₂ will depend on the material properties of both metal interfaces, the angle of incidence (θ_{I}), and on λ [3]. The confinement length has dimensions of length and determines the distance over which the electric field intensity decays by a factor of e in the lateral dimension. That is, the shorter the confinement length, the more laterally confined the inhomogeneous surface plasmon polariton wave is, and the smaller the fluorophore excitation area is. Therefore, higher the lateral resolution is achieved for smaller confinement lengths. For a given wavelength and set of materials, the confinement length can be modulated by changing θ_{I} which is controllable externally by the polarization filter (see FIG. 1, FIG. 3, and FIG. 4).

### 6. REFERENCES

1. D. Axelrod, N. L. Thompson, T. P. Burghard, “Total internal reflection Microscopy”, J. Microsc., 129, 19-28, (1983)
2. Y. Aono, T. Mochizuki, K. Osa, “Total internal reflection fluorescence microscope”, U.S. Pat. No. 7,385,758 B2
3. J. J. Foley IV, J. M. McMahon, G. C. Schatz. H. Harutyunyan, G. P. Wiederrecht, S. K. Gray, “Inhomogeneous surface plasmon polaritons”, ACS Photonics, 1, 739-745, (2014)
4. L. Schermella, R. Heintzmann, H. Leonhardt, “A guide to super-resolution fluorescence microscopy”, J. Cell. Biol., 190 165-175 (2010).

1. An inhomogeneous surface wave microscope including a light source, a polarization filter, a high numerical aperture objective, and a substrate consisting of a total internal reflection prism coated with laterally-interfaced nanoscopic films of at least two different plasmonic materials.

2. A microscope according to claim 1, characterized in that plasmonic materials are noble metals

3. A microscope according to claim 1, characterized in that the plasmonic materials are plasmonic ceramics,

4. A microscope according to claim 1, characterized in that the plasmonic materials are semiconductors,

5. A microscope according to claim 1, characterized in that the plasmonic materials are novel alloys.

6. A microscope according to claim 1, characterized in that the two nanoscopic thin films each individually support surface plasmon polaritons at the optical wavelength of interest

7. A microscope according to claim 1, characterized in that the surface plasmon polaritons supported by the two nanoscopic thin films are characterized by unique propagation vectors [1].

8. A microscope according to claim 1, that is characterized by having a high numerical aperature objective that can focus the incident light to large angles Θ_{I} that when are incident upon metal 1 nanofilm through the total internal reflection prism, can satisfy the surface plasmon polariton resonance condition given by
$$\sqrt{{ε}_{prism}} sin ( {Θ}_{I} ) = \sqrt{\frac{{ε}_{m 1} ( λ ) \cdot {ε}_{S}}{{ε}_{m 2} ( λ ) + {ε}_{S}}} ,$$
where ∈ₚᵣᵢₛₘ is the dielectric constant of the prism, ∈ₘ₁(λ) is the (wavelength dependent and complex-valued) dielectric function of metal 1 nanofilm, and ∈_{S} is the dielectric constant of the superstrate of the metal nanofilm, which may include the specimen being imaged or any immersion material.

9. A microscope according to claim 7, characterized by having total internal reflection prism in which ∈ₚᵣᵢₛₘ>∈_{S}.

10. A microscope according to claim 7, characterized by having a total internal reflection prism made of glass.

11. A microscope according to claim 7, characterized by having a total internal reflection prism made of dielectric polymers.

12. A microscope according to claim 7, characterized by having a total internal reflection prism made of metal oxides.

13. A microscope according to claim 7, characterized by having a superstrate material made of aqueous solutions.

14. A microscope according to claim 7, characterized by having a superstrate material made of immersion oil suspensions.

15. A microscope according to claim 1, in which the surface plasmon polariton excited upon metal 1 nanofilm propagates along a certain direction with respect to the normal to the interface between metal 1 nanofilm and metal 2 nanofilm, in which the angle of the propagation direction relative to the normal to the lateral interface is characterized by angle θ_{I}, which is equal to the polarization angle of the light incident upon the prism in the x-y plane which is controlled by the polarization filter.

16. A microscope according to claim 1, in which an inhomogeneous surface plasmon polariton is directly excited upon metal 1 nanofilm and with its propagation component having a certain angle θ_{I} and its evanescent component having a certain angle φ_{I} in the x-y plane which is controlled by the polarization filter or other means.

17. A microscope according to claim 1, in which fluorescent labels in a sample are selectively excited by a laterally-evanescent wave with characteristic confinement length defined by
$${L}_{C} = \frac{λ}{4 π {K}_{2} sin ( {θ}_{2} - {φ}_{2} )}$$
where ω is the angular frequency of the incident light, c is the speed of light, and K₂ sin(θ₂−φ₂) can be calculated from complex Snell's Law [1] and from the properties of the Inhomogeneous Wave Microscopy substrate.

18. A microscope according to claim 1, in which the lateral resolution is enhanced by modulating the confinement length defined by
$${L}_{C} = \frac{λ}{4 π {K}_{2} sin ( {θ}_{2} - {φ}_{2} )}$$
through use of the polarization filter where ω is the angular frequency of the incident light, c is the speed of light, and K₂ sin(θ₂−φ₂) can be calculated from complex Snell's Law [1] and from the properties of the Inhomogencous Wave Microscopy substrate.

19. A microscope according to claim 1, in which the lateral resolution is enhanced by modulating the confinement length defined by
$${L}_{C} = \frac{λ}{4 π {K}_{2} sin ( {θ}_{2} - {φ}_{2} )}$$
through engineering of the substrate and/or superstrate material and/or immersion medium where ω is the angular frequency of the incident light, c is the speed of light, and K₂ sin(θ₂−φ₂) can be calculated from complex Snell's Law [1] and from the properties of the Inhomogeneous Wave Microscopy substrate.
